(19) United States
(12) Patent Application Publication
(10) Pub. No.: US 2013/0336473 A1
(43) Pub. Date: Dec. 19, 2013

(54) DISPLAY DEVICE

(71) Applicant: SYNERGY OPTOELECTRONICS (SHENZHEN) CO., LTD., Shenzhen (CN)

(72) Inventors: BING XU, Shenzhen (CN); SUI-MANG SONG, Shenzhen (CN); CHIEN-CHUNG FANG, Hsinchu (TW)

(21) Appl. No.: 13/904,160

(22) Filed: May 29, 2013

(30) Foreign Application Priority Data
Jun. 15, 2012 (CN) 2012101979000

(51) Int. Cl. H04M 1/02

(52) U.S. Cl. CPC H04M 1/0295
USPC 379/428.03

(57) ABSTRACT

A display device on a supporting base utilizes the surface area of the support base to house a handset of a wireless telephone, a small touch screen, a microphone, a loudspeaker, and a switch. A communication module within the support base permits wireless communication between all components, incoming and outgoing calls may be managed on a hands-free basis, and the display of information relevant to external communications may be switched between the touch screen and a large upper screen of the display device.

### BACKGROUND

1. Technical Field

The disclosure relates to display devices, and particularly to a display device for computing systems.

2. Description of Related Art

Display devices of computing systems have a display portion and a supporting portion. The supporting portion includes a bracket and a base. Usually, the base has no function beyond being used to support the display portion and real estate on desks is consumed for very little return. In addition, in many offices where the display devices are used, fixed telephones may be required which require their own space on the desks. Further, the fixed telephone may have a small display for displaying communication information. The displayed communication information may be limited and not clear enough due to dimensions of the small display. Therefore, there is room for improvement in the art.

### BRIEF DESCRIPTION OF THE DRAWINGS

The accompanying drawings are included to provide a further understanding of the disclosure, and are incorporated in and constitute a part of this application. The drawings illustrate embodiments of the disclosure and, together with the description, serve to explain the principles of the disclosure.

FIG. 1 is a schematic view of a display device according to an exemplary embodiment.

FIG. 2 is a schematic view of a touch screen of the display device rotated out from a receiving groove of FIG. 1.

FIG. 3 is an exploded schematic view of the display device of FIG. 1.

### DETAILED DESCRIPTION

Examples of the present embodiments are illustrated in the accompanying drawings. Wherever possible, the same or similar reference numbers are used, in the drawings and the description, to refer to the same or like parts.

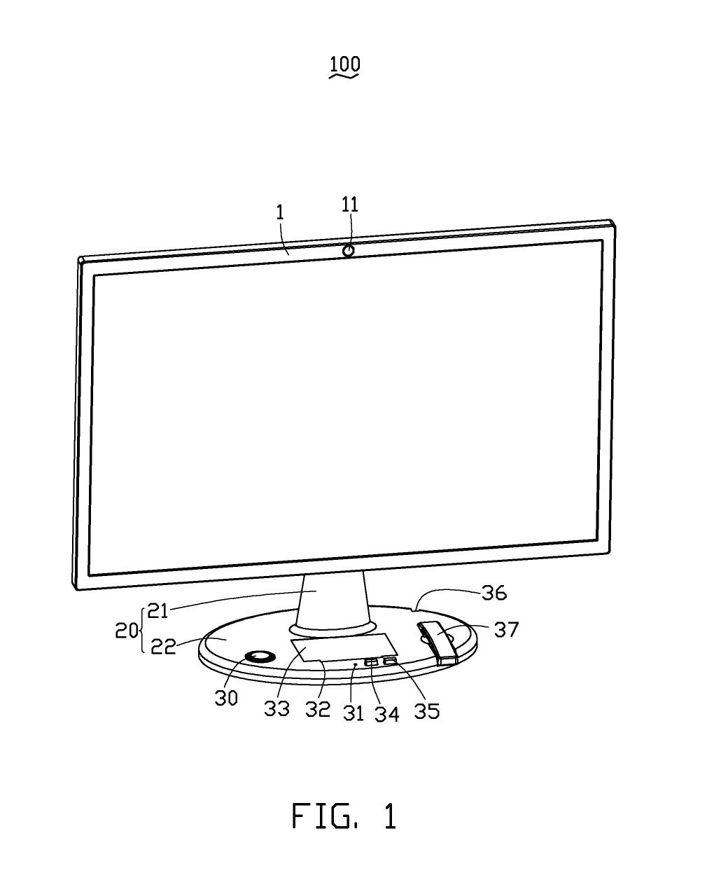

Referring to FIG. 1 to FIG. 3, a display device 100 according to an exemplary embodiment is shown. The display device 100 includes a display portion 1, a supporting portion, a touch screen 33, a telephone receiver 37, and a communication module 39. The display portion 1 displays information under the control of an electronic device electronically connected to the display portion 1. The display portion 1 includes a display screen and a shell that accommodates and supports the display screen.

The supporting portion 20 includes a bracket 21 and a base 22. In this embodiment, the base 22 is in shape of an elongated circle. One end of the bracket 21 is perpendicularly fixed to the base 21, and another end of the bracket 21 is fixed to or pivots from the shell of the display portion 1 to support the display portion 1.

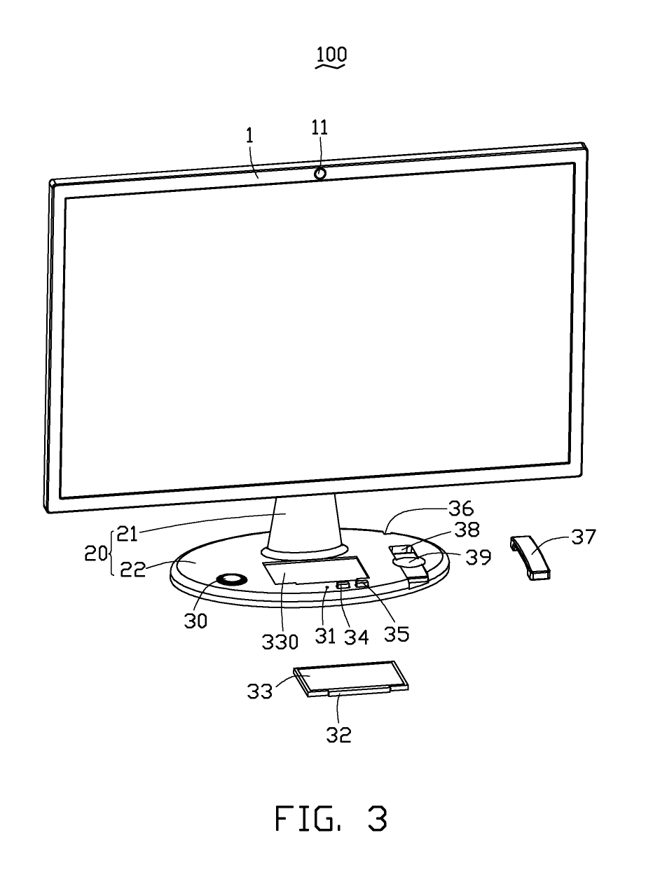

One side of the base 22 defines first receiving groove 38. As shown in FIG. 3, the first receiving groove 38 is defined at the right side of the bracket 21 and is cuboid shaped. The telephone receiver 37 is fixed to and partially received in the first receiving groove 38. The communication module 39 is embedded within the inner space of the first receiving groove 38 to communicate with external communication devices (e.g., other phones) and the telephone receiver 37. The communication module 39 receives electronic signals from the external communication devices and audibly outputs the received electronic signals through the telephone receiver 37. Further, the communication module 39 receives sounds input by a user using the telephone receiver 37, and transmits the sounds as signals to an external communication device which communicates with the communication module 39. In one embodiment, the telephone receiver 37 is a wireless receiver. The communication module 39 may include a wireless communication module, such as a BLUETOOTH® module, corresponding to the telephone receiver 37, to establish a wireless communication between the telephone receiver 37 and the communication module 39.

Size of the touch screen 33 is smaller than that of the screen of the display portion 1, and is electronically connected to the communication module 39. The touch screen 33 displays information relevant to the communication module 39, such as phone numbers of incoming calls, phone directory, communication counts and durations, and other information. The touch screen 33 includes a virtual keypad to provide a dialing function for the communication module 39. In an alternative embodiment, a physical keypad is defined on the telephone receiver 37, to provide the dialing function of the communication module 39.

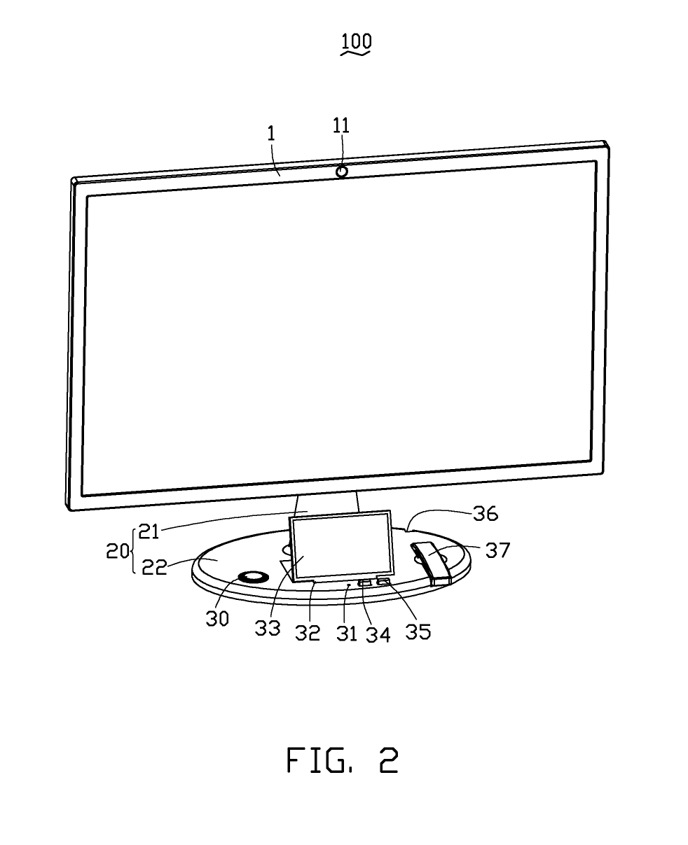

The base 22 further defines a second receiving groove 330. In this embodiment, the second receiving groove 330 is defined in front of the bracket 31 and spaced from the first receiving groove 38. The second receiving groove 330 receives and supports the touch screen 33. The touch screen 33 includes a rotating shaft 32 at a side, to rotatably attach the touch screen 33 to a sidewall of the second receiving groove 330 far away from the bracket 21. In the embodiment, the sidewall of the second receiving groove 330 far away from the bracket 21 defines two notches. Two opposite ends of the rotating shaft 32 are inserted into the notches. Thus, the touch screen 33 can be laid flush in the second receiving groove 330 (as shown in FIG. 1) by rotating the touch screen 330 towards the bracket 21. When the touch screen 33 is rotated up and out of the second receiving groove 330, the touch screen 33 stands on the base 22 at an angle between the touch screen 33 and the base 22 (as shown in FIG. 2).

In the embodiment, the display device 100 further includes a speaker 30, a microphone 31, a switching button 34, a hands free button 35, and a network interface 36. The microphone 31, the switching button 34, and the hands free button 35 are lined along a line in front of the second receiving groove 330. The speaker 30 is defined at another side of the base 22 opposite to the telephone receiver 37. The microphone 31, the speaker 30, and the hands free button 35 are electronically connected to the communication module 39 to provide a hands free communication function for the communication module 39. When the communication module 39 receives an incoming call from the external communication device, signals of the incoming call are output as audio through the speaker when the hands free button 35 is pressed. At this time, the microphone 31 receives sounds input by the user and transmits the sounds as signals to the external communication device through the communication module 39, thereby realizing the hands free communication function of the communication module 39.

The network interface 36 is defined at a backside of the base 22, to connect the display device 100 to a network.

The switching button 34 is configured to switch information between display on the display portion 1 and display on the touch screen 33. For example, when the switching button 34 is pressed, the information displayed on the display portion 1 is switched to the touch screen 33, conversely the information displayed on the touch screen 33 is switched to the display portion 1.

In the embodiment, the display device 100 further comprises an image capturing device 11 installed on the display portion 1. The image capturing device 11 captures images of the scene in front of the display device 100 to realize a video communication function of the display device 100. When a video communication is established between the display device 100 and an external communication device, one of the display portion 1 and the touch screen 33 displays the images captured by the image capturing device, and another of the display portion 1 and the touch screen 33 displays images transmitted from the external communication device. The images captured by the image capturing device 11 are transmitted to the external communication device through the communication module 39. The image capturing device 11 may be, for example, a camera mounted on the top edge of the display portion 1.

In other embodiments, the display screen of the display portion 1 may be touch screen which includes a virtual keyboard, to provide the dialing function of the communication module 39 using the display screen of the display portion 1.

Although numerous characteristics and advantages of the present embodiments have been set out in the foregoing description, together with details of the structures and functions of the embodiments, the disclosure is illustrative only; and changes may be made in detail, especially in the matters of shape, size and arrangement of parts within the principles of the disclosure to the full extent indicated by the broad general meaning of the terms in which the appended claims are expressed.

What is claimed is:

1. A display device, comprising:
a display portion;
a supporting portion comprising a bracket and a base, the bracket connected between the display portion and the base to supporting the display portion, the base defining a first receiving groove;
a telephone receiver fixed to and partially received in the first receiving groove; and
a communication module embedded within an inner space of the first receiving groove to communicate with external communication devices and the telephone receiver;
wherein when the communication module communicates with an external communication device, the communication module receives electronic signals from the external communication device and audibly outputs the received electronic signals through the telephone receiver, and receives sound input by a user through the telephone receiver and transmits the sounds as signals to the external communication device.

2. The display device as claimed in claim 1, wherein the telephone receiver is a wireless receiver, and the communication module includes a wireless communication module to establish a wireless communication between the telephone receiver and the communication module.

3. The display device as claimed in claim 1, further comprising a touch screen electronically connected to the communication module, the touch screen displaying information relevant to the communication module.

4. The display device as claimed in claim 3, wherein the touch screen comprises a rotating shaft rotatably attaching the touch screen to the base.

5. The display device as claimed in claim 4, wherein base further defines a second receiving groove, a sidewall of the second receiving groove far away from the bracket defines two notches, and two opposite ends of the rotating shaft are inserted into the notches to rotatably attach the touch screen to the second receiving groove.

6. The display device as claimed in claim 5, wherein the touch screen is laid flush in the second receiving groove by rotating the touch screen towards the bracket, and the touch screen stands on the base at an angle between the touch screen and the base when the touch screen is rotated up and out of the second receiving groove.

7. The display device as claimed in claim 3, further comprising a switching button defined on the base and configured to switch information between display on the display portion and display on the touch screen.

8. The display device as claimed in claim 3, wherein the touch screen is electronically connected to the communication module, and the touch screen comprises a virtual keypad to provide a dialing function for the communication module.

9. The display device as claimed in claim 3, further comprising an image capturing device that is installed on the display portion and captures images of the scene in front of the display device, to provide a video communication function for the display device.

10. The display device as claimed in claim 9, wherein when a video communication is established between the display device and an external communication device, one of the display portion and the touch screen displays the images captured by the image capturing device, and another of the display portion and the touch screen displays images transmitted from the external communication device.

11. The display device as claimed in claim 10, wherein the images captured by the image capturing device are transmitted to the external communication device through the communication module.

12. The display device as claimed in claim 1, further comprising a speaker, a microphone, and a hands free button defined on the base, wherein the microphone, the speaker, and the hands free button are electronically connected to the communication module to provide a hands free communication function for the communication module; when the hands free button is pressed, the electronic signals received from the external communication device are output as audio through the speaker, and the microphone receives sounds input by the user and transmits the sounds as signals to the external communication device through the communication module.

13. The display device as claimed in claim 1, further comprising a network interface defined at a backside of the base to connect the display device to a network.

14. The display device as claimed in claim 1, wherein the display portion comprises a display screen and a shell that accommodates and fixes the display screen.

15. The display device as claimed in claim 14, wherein the display screen of the display portion is a touch screen comprising a virtual keyboard, to provide a dialing function for the communication module using the display screen of the display portion.
